(19) United States
(12) Patent Application Publication
(10) Pub. No.: US 2011/0001056 A1
(43) Pub. Date: Jan. 6, 2011

(54) COMPONENT FOR MANIPULATING A STREAM OF CHARGED PARTICLES

(75) Inventors: Richard Stresau, Sydney (AU); Wayne Sheils, Winmalee (AU); Kevin Hunter, Glenhaven (AU)

Correspondence Address: FULWIDER PATTON LLP, HOWARD HUGHES CENTER, 6060 CENTER DRIVE, TENTH FLOOR, LOS ANGELES, CA, 90045, US

(73) Assignee: SGE ANALYTICAL SCIENCES PTY LTD, Ringwood (AU)

(21) Appl. No.: 12/829,207

(22) Filed: Jul. 1, 2010

Related U.S. Application Data
(60) Provisional application No. 61/222,295, filed on Jul. 1, 2009.

(51) Int. Cl. H01J 3/18; H01J 3/26

(52) U.S. Cl. 250/396 R

(57) ABSTRACT

An apparatus for manipulating the trajectories of moving charged particles. The apparatus includes a grid of laterally spaced side by side elongate elements and means defining a path for charged particles to traverse the grid. The grid is supported and configured for application of a voltage gradient between and/or along the elongate elements, whereby to manipulate the trajectories of charged particles that traverse the grid. A method of manipulating the trajectories of moving charged particles is also disclosed.

### FIELD OF INVENTION

This invention relates generally to changing the direction of travel of charged particles and (although capable of other, more complex functions) the descriptions are concerned in particular with alternatives to the conventional methods of charged particle deflection and focussing.

In the context of this specification, a “particle” may be an ion or electron or other charged particle. For convenience, particles to be manipulated will sometimes be referred to herein as ions and a plurality of ions moving generally in the same direction will be referred to as an ion beam.

### BACKGROUND ART

Although the invention can be configured for a wide variety of applications, two different examples of conventional components will be described as an instructive method of introducing the new concepts: ion deflection and ion focusing.

Electrostatic ion deflection is generally achieved by passing an ion beam between two conductive plates where different voltages are applied to each plate (deflection plates). The ion beam is attracted toward the plate which has the opposite polarity of the ion's charge: positive ions are attracted toward the negative plate and thus deflected or in other words their direction of travel has been altered.

In very simple terms, ion focusing is generally achieved by passing an ion beam through a circular aperture in a metal plate where a voltage is applied to the plate and other elements in the system such that the electrostatic field strength is different from one side of the plate to the other. The visible optics equivalent is a lens.

These components are widely used in a variety of ion/electron optics systems such as mass spectrometers, electron microscopes and cathode ray tubes.

### SUMMARY OF INVENTION

This invention is a new arrangement based on parallel wire grids that are commonly used in ion optical systems. Such grids consist of multiple parallel wires attached to an electrically conductive frame so that all wires are at a common voltage. The grids function as a method of controlling electrostatic fields with a component that is nominally transparent to ions.

In generalized terms the invention consists of a grid composed of plural laterally spaced side by side elongate elements supported and configured for application of a voltage gradient between and/or along said elongate elements, whereby to manipulate the trajectories of charged particles that traverse the grid.

In one aspect, the invention provides an apparatus for manipulating the trajectories of moving charged particles, including:
a grid of laterally spaced side by side elongate elements; and
means defining a path for charged particles to traverse said grid;
wherein said grid is supported and configured for application of a voltage gradient between and/or along said elongate elements, whereby to manipulate the trajectories of charged particles that traverse the grid.

In another aspect, the invention provides a method of manipulating the trajectories of moving charged particles, comprising:
positioning in the path of the charged particles a grid of laterally spaced side by side elongate elements, wherein the charged particles traverse the grid; and
applying a voltage gradient between and/or along the elongate elements of the grid, whereby to manipulate the trajectories of the charged particles as they traverse the grid.

### EMBODIMENTS OF THE INVENTION

The elongate elements may be supported on an insulating substrate in which a hole is formed to in part define the path for charged particles.

The elongate elements may typically be wires and are preferably electrically conducting.

The elongate elements are preferably parallel.

In an embodiment of the invention, each wire is positioned so that each of its ends is at an opposite edge of the substrate, and the wires are attached to the substrate at their ends. A hole in the substrate is positioned so that each wire traverses the hole. This hole provides a path for an ion beam so that it can pass through the grid of wires and then through the hole.

In one implementation of the invention, the grid is configured for application of a voltage gradient between the wires by means of a strip of an electrically resistive material which is positioned, eg. along one edge of the substrate, in such a way that all of the wires make electrical contact to the same resistive strip but at different positions along the resistive strip. Nominally and in the simplest implementation of the invention, the wires contact the resistive material at near equally spaced positions along the resistive strip so that each wire becomes a different contact on a voltage divider formed by this arrangement. When attaching a voltage between the opposite ends of the resistive strip, a different voltage level will be applied to each wire of the grid because each wire becomes a different contact of the voltage divider which is formed by this arrangement.

An alternative implementation utilizes a resistive substrate rather than an insulating substrate, in which case a resistive strip will not always be necessary as the resistive substrate itself may be employed to apply the voltage gradient between the wires.

To achieve a simple deflection of the ion beam passing through the grid (deflection grid mode) the resistive material is configured so that the resistance per unit length is substantially constant along the resistive strip. In this way the voltage inherently applied to each wire of the grid will be substantially linear with respect to its position along the resistive strip and the voltage difference between any adjacent set of wires will be substantially equal to that of all the others. As a result, ions passing through the grid will be subjected to the same electrostatic field strength and direction throughout the entire plane of the grid and thus will be deflected by the same angle and orientation independent of the position where they transit the grid plane.

Of course there will be local deviations from this nominal uniform deflection due to electrostatic field variations in the local vicinity of the wires. However, for small deflection angles these deviations will be of the same magnitude that is encountered when using conventional grids (where all wires are at the same voltage level) which are commonly used in ion optics systems and the same methods conventionally used to evaluate the level of these distortions will also be appropriate for the deflection grids described herein. Therefore, the parameters used to define the quality of a conventional grid required for a specific ion optics system (such as a time-of-flight mass spectrometer) will also be appropriate for these deflection grids and hence conventional fabrication techniques will also be appropriate.

The actual angular deflection of the ion beam transiting the deflection grid will be a function of the ion energy and the voltage applied between the two ends of the resistive strip (strip voltage). Therefore, the deflection angle will be adjustable by adjusting strip voltage. Placing two such deflection grids in a series so that the ion beam traverses both of them and orienting the grids so that the wires of one grid are substantially orthogonal to those of the other will provide a system capable of steering the ion beam in any orientation. (These two grids could be applied to opposite sides of the same insulating substrate.) Appropriately varying the voltages on each of the grids enables the assembly to deflect the ion beam through any angle and orientation (within limits). (As a practical matter the ion beam distortion will increase as the deflection angle increases, so the maximum practical deflection angle will be determined by the level of ion beam distortion that is tolerable in the specific application.) This combined (2 axis) deflection system could significantly improve the resolution of a time-of-flight mass spectrometer where the ion beam orientation with respect to the final detector ion impact surface is critical. The voltage control of the combined grids would enable dynamic adjustment of beam angle while monitoring spectral resolution (or peak width) of the system.

Of course this could be accomplished with conventional deflection plates (described above). However, these would require a large volume of space within the instrument and these deflection plate configurations are prone to additional beam distortion. Both these issues are alleviated by a deflection grid according to an embodiment of the invention.

Another implementation of the invention utilizes a non-linear resistive strip. In one example of this version the resistance per unit length would vary such that it would follow the equation of a circle with either the maximum or minimum resistance position coinciding with the center of the resistive strip. Assuming the resistive material was chosen to have near uniform planar resistivity, this could be achieved by organizing the geometry of the resistive strip so that its outline followed this geometric shape (one or both edges of the resistive strip following a portion of a circle). An electrical contact point would be positioned at this center point along with the two contact points at both of the extreme ends of the resistive strip as described above. Placing the same voltage level at the two ends of the resistive strip and a different voltage level in the center would result in greater (or lesser) deflection near the extreme end wires than near the center. With the appropriate resistive profile on the resistive strip the deflections can be organized so that all ion trajectories cross at a single line that is parallel to the grid wires (a focal line). If this focal line is after the grid (along the ion travel direction) the grid becomes the ion optics equivalent of a visible optics convex cylinder lens. If the focal line is before the grid it will be the ion optics equivalent of a concave cylinder lens. The focal line position will be a function of the ion energy, voltage level and polarity difference between the center and outer contacts. Adjusting the center to outer voltage level will dynamically change the effective focal length (focus position) of the grid. Combining two such grids orthogonally as described above will result in the equivalent of a conventional point focusing lens.

The above description specifies applying the same voltage level to the extreme ends of the resistive strip with a different voltage level applied only at the center contact.

Adjusting the end voltage levels independently as well as the center contact voltage level would enable the functional combination of the deflection grid device and the focusing grid device in one unit.

A further enhancement of the focusing grid assembly described above would organize the resistance per unit length profile along the resistive strip to minimize focusing distortions. Using a simple circular resistive profile as suggested above would lead to significant distortions in some applications: the equivalent of spherical aberration in a visible optics lens. The appropriate resistive profile could be generated utilizing electro/ion optics simulation software such as Simion (a commercially available computer software program). Combining such software with a multidimensional simplex optimizing algorithm will enable the generation of an appropriate resistive profile to a level of accuracy limited only by the level of applied computing power and the grid fabrication techniques. The result would be the ion optics equivalent of a visible optics aspheric lens. Utilizing this technique would offer a significant performance improvement over the conventional ion optic lens: a hole in a metal plate.

The variation in resistivity per unit length for the resistive strips can be accomplished by utilizing resistive materials that are printed (or otherwise applied) onto the insulating substrate with a non-linear profile. Using a resistive material with uniform bulk resistivity and uniform thickness will result in a resistive profile that corresponds to the geometrical profile of the resistive material. A geometric profile with linear sides will result in a linear resistivity profile. A non-linear geometric profile will result in a corresponding resistive profile.

In another implementation of the invention, also applicable as a deflection grid, the elongate elements are resistive wires, and a conductive strip is provided instead of a resistive strip. Each end of the resistive grid wires makes electrical contact to conductive strips which are positioned at the edges of an insulating substrate that supports the wires. This implementation essentially performs the same function as the deflection grid with conductive wires, but with the deflection voltage applied between the two conductive strips and a voltage gradient applied along the wires.

A further variation utilizes both resistive wires and resistive strips on the edges of the insulating substrate. This device entails respective voltage gradients between the wires and along the wires, enabling deflection in two axes with only one grid.

The devices describe above can be fabricated with commercially available materials. Appropriate alumina ceramic can be laser cut to the required shapes. Tungsten wire of appropriate diameter can be attached to the alumina with epoxy glues. Resistive inks (Asashi, Japan) can be screen printed onto the alumina substrates and cured with the wires in place and thus making electrical contact. The resistive inks can be screen printed into any shape enabling fine, reproducible control over their resistive profile. Carbon nano-tube woven wires have appropriate resistances to enable fabrication of the resistive wire concept.

1. Apparatus for manipulating the trajectories of moving charged particles, including:
a grid of laterally spaced side by side elongate elements; and
means defining a path for charged particles to traverse said grid;
wherein said grid is supported and configured for application of a voltage gradient between and/or along said elongate elements, whereby to manipulate the trajectories of charged particles that traverse the grid.

2. Apparatus according to claim 1 wherein said elongate elements are supported on an insulating substrate in which a hole is formed to in part define the path for charged particles.

3. Apparatus according to claim 2 wherein each elongate element is positioned so that each of its ends is at an opposite edge of the substrate, the elongate elements are attached to the substrate at their ends, and said hole in the substrate is positioned so that each elongate element traverses the hole.

4. Apparatus according to claim 1 wherein said elongate elements are wires.

5. Apparatus according to claim 1 wherein the elongate elements are parallel.

6. Apparatus according to claim 4 wherein said grid is configured for application of a voltage gradient between the wires by means of a strip of an electrically resistive material which is positioned, eg. along one edge of the substrate, in such a way that all of the wires make electrical contact to the same resistive strip but at different positions along the resistive strip.

7. Apparatus according to claim 6 wherein the resistive material is configured so that the resistance per unit length is substantially constant along the resistive strip.

8. Apparatus according to claim 1 wherein said elongate elements are supported on a resistive substrate in which a hole is formed to in part define the path for charged particles.

9. A method of manipulating the trajectories of moving charged particles, comprising:
positioning in the path of the charged particles a grid of laterally spaced side by side elongate elements, wherein the charged particles traverse the grid; and
applying a voltage gradient between and/or along the elongate elements of the grid, whereby to manipulate the trajectories of the charged particles as they traverse the grid.

10. Apparatus according to claim 2 wherein said elongate elements are wires.

11. Apparatus according to claim 3 wherein said elongate elements are wires.

12. Apparatus according to claim 10 wherein said grid is configured for application of a voltage gradient between the wires by means of a strip of an electrically resistive material which is positioned, eg. along one edge of the substrate, in such a way that all of the wires make electrical contact to the same resistive strip but at different positions along the resistive strip.

13. Apparatus according to claim 11 wherein said grid is configured for application of a voltage gradient between the wires by means of a strip of an electrically resistive material which is positioned, eg. along one edge of the substrate, in such a way that all of the wires make electrical contact to the same resistive strip but at different positions along the resistive strip.

14. Apparatus according to claim 12 wherein the resistive material is configured so that the resistance per unit length is substantially constant along the resistive strip.

15. Apparatus according to claim 13 wherein the resistive material is configured so that the resistance per unit length is substantially constant along the resistive strip.
